(19) United States
(12) Patent Application Publication
(10) Pub. No.: US 2022/0332061 A1
(43) Pub. Date: Oct. 20, 2022

(54) PULTRUSION DEVICE FOR CURVED PROFILED ARTICLES

(71) Applicant: KRAUSSMAFFEI TECHNOLOGIES GMBH, München (DE)

(72) Inventor: Sebastian Schmidhuber, München (DE)

(21) Appl. No.: 17/761,635

(22) PCT Filed: Sep. 9, 2020
(86) PCT No.: PCT/EP2020/075189

§ 371 Date: Mar. 18, 2022

(30) Foreign Application Priority Data
Oct. 8, 2019 (DE) 10 2019 127 025.1

(51) Int. Cl. B29C 70/52

(52) U.S. Cl. CPC B29C 70/526; B29C 70/521

(57) ABSTRACT

A pultrusion device for producing fiber-reinforced profiled articles including: a fiber feed for feeding a fiber bundle; an impregnating tool for impregnating the fiber bundle fed by the fiber feed with a pultrusion matrix; and a shaping tool for forming and curing the fiber bundle impregnated with the pultrusion matrix, in order to produce a fiber-reinforced profiled article. The shaping tool is suitable for moving, in the shaping tool, the fiber bundle impregnated with the pultrusion matrix through a plurality of openings, the inner contours of which define the outer contour of the fiber-reinforced profiled article and which are each fixed in the direction of movement of the fiber bundle. The shaping tool is also suitable for changing, during operation of the pultrusion device, cross-sections of the openings perpendicular to the direction of movement in such a way that the cross-sectional areas of the openings remain constant.

The invention relates to pultrusion devices which are suitable for producing fibre-reinforced profiled articles with changeable cross-sections or of curved fibre-reinforced profiled articles.

In pultrusion, usually fibre-reinforced profiled articles are produced as solid or hollow profiled articles with a constant cross-section and without curvature. Here, a fibre bundle which is impregnated with a pultrusion matrix is drawn through a hollow contour and, in so doing, is cured. The shape of the hollow contour determines here the exterior shape of the profiled article. The apparatus consists here of fixed components through which the fibre bundle is moved. The linearity, i.e. the freedom from curvature, of the profiled articles and their constant cross-section, results therefrom.

In addition to this technology, it is also possible to produce profiled articles which are intrinsically curved, by the contour for forming the profiled article being configured in a movable manner. Here, the impregnated fibre bundle is cured in a moving tool, the tool itself shapes the impregnated fibre bundle through its own geometry or respectively through the geometry on which it is moved. By segmenting of the contour by means of adjustable individual components, a variety of curved, fibre-reinforced profiled articles can be produced.

However, for adjusting the shape of the profiled article, in particular the cross-section, the entire system must be switched off and a modification must be carried out. It is not possible to carry out a change of the cross-section of a profiled article while the pultrusion process is running.

It is therefore an object of the present invention to indicate a pultrusion device, by which fibre-reinforced profiled articles which can have changeable cross-sections or can be curved, can be produced without interruptions of the process sequence.

This problem is solved by the subject of the independent claim. Advantageous further developments are indicated in the dependent claims.

For example, a pultrusion device for producing fibre-reinforced profiled articles can have a fibre feed for feeding a fibre bundle, an impregnating tool for impregnating the fibre bundle fed by the fibre feed in a pultrusion matrix, and a shaping tool for forming and curing the fibre bundle impregnated with the pultrusion matrix, in order to produce a fibre-reinforced profiled article. Here, the shaping tool is suitable for moving, in the shaping tool, the fibre bundle impregnated with the pultrusion matrix through a plurality of openings, the inner contours of which define the outer contour of the fibre-reinforced profiled article and which are each fixed in the direction of movement of the fibre bundle. The shaping tool is also suitable for changing, during an operation of the pultrusion device, cross-sections of the openings perpendicular to the direction of movement in such a way that the cross-sectional areas of the openings remain constant.

A pultrusion device is therefore provided, in which the shape of the profiled article which is to be produced is determined by several different openings through which a fibre bundle (glass fibres, carbon-, aramid fibres or suchlike), impregnated with pultrusion matrix, typically a resin or suchlike, is directed. The impregnating with pultrusion matrix takes place here in an impregnating tool, for instance an impregnating bath or an injection box. The impregnating can occur before the shaping, but also directly during the shaping. The impregnating tool and shaping tool are then only functionally distinguishable, but not spatially separated.

The arrangement of the openings and their cross-sections determine the course of the fibre bundle through the shaping tool. When all openings lie on a line and have the same cross-section, it is possible to produce linear profiled articles in the conventional manner.

The term “opening” is to be understood here to mean that all the contours are to be included thereby which are suitable for receiving in them the fibre bundle, forming and directing it in the shaping tool. Various openings are differentiated in that their cross-section can be changed independently of one another. A change of the cross-section is to be understood here to mean not only the change of the inner contour of the opening but also a shifting of the opening perpendicular to the direction of movement without a change of the inner contour. A change of the cross-section in the sense of the invention is therefore present when the cross-sections of the same opening do not overlap one another at different times.

The openings in the shaping tool are fixed, i.e. they do not move, in relation to the fibre bundle, along the direction of movement. The pultrusion therefore takes place only in that the fibre bundle, impregnated with resin, is drawn through the shaping tool. A stopping of the fibre bundle and a moving of the shaping tool in relation to the fibre bundle do not occur, or respectively are not essential for the pultrusion of the fibre-reinforced profiled articles.

The openings are adjustable solely perpendicular to the direction of movement of the fibre bundle through the shaping tool. This adjustment takes place in such a way that the cross-sectional area remains constant, but the dimensions can be changed. Thereby, it is ensured that the proportion of the fibres in the total volume of the fibre bundle, impregnated with pultrusion matrix, remains constant. In other words, through the constant opening cross-sections it is ensured that the quantity of pultrusion matrix per fibre remains identical.

The shape of the various openings, i.e. the contour which they give to the profiled article, can be different here, as long as the areas of the opening cross-sections are identical. This can be used e.g. in order to convert from one contour to another contour while the operation is running. For this, e.g. all the openings have the same cross-sections initially, in order to produce a first contour. Beginning with the opening which lies nearest to the fibre feed, the cross-section is converted to a second contour. The fibre bundle therefore changes its contour within the shaping tool. The location of the contour change travels owing to the movement of the fibre bundle through the shaping tool. In order to maintain the second contour, the cross-sections of all the openings are changed sequentially in accordance with this second contour. This therefore allows different profile cross-sections to be achieved, without having to stop the pultrusion. This naturally increases the production rate due to a reduced downtime.

In a similar manner, it is also possible to produce curved profiled articles in a continuous manner. For this, the shaping tool is suitable for changing the cross-sections of the openings in such a way that the inner contours of the openings define a desired curvature for the outer contour of the fibre-reinforced profiled article. The cross-sections of the openings can then be changed in such a way that the curvature is maintained on moving of the fibre bundle through the openings.

The openings can therefore, for example, all have the same cross-sectional shape, but are not arranged on a line, but rather define a curvature. For example, centre points of the openings can lie on a circular arc or on a sine line. When the fibre bundle is moved further in the next moment, the openings are shifted perpendicular to the direction of movement in such a way that the initial curvature shape is maintained. Observing the combination of the openings as a single “curvature figure”, this curvature figure therefore shifts at the same speed through the shaping tool at which the fibre bundle is also moved through the shaping tool. Individual partial regions of the fibre bundle are always surrounded by the same contour, formed by (different) openings.

Hereby, it is possible to cure the fibre bundle with a particular curvature which co-travels with the fibre bundle. The openings lying nearest to the fibre feed continue the curvature of the profiled article with advancing transport of the fibre bundle through the shaping tool. In this way, curved profiled articles can be pultruded continuously, i.e. at constant speed of movement of the fibre bundle. In addition, the curvature of the pultruded profiled article can be changed without changing the pultrusion process, by the openings being moved in such a way that instead of a first curvature figure (e.g. a circular arc segment), a second curvature figure (e.g. a segment of a sine curve) is formed through the openings and travels through the shaping tool. It is therefore possible to adjust various curvatures for fibre-reinforced profiled articles in a simple manner and without stopping the pultrusion system.

The shaping tool can have seals which are arranged within the openings and form a channel, leading through all the openings, for the fibre bundle impregnated with the pultrusion matrix. Thereby, in addition to the openings, a further structure is provided for the supporting of the fibre bundle, through which the outer contour of the fibre bundle can be configured more smoothly. In addition, such seals, which connect all the openings, prevent pultrusion matrix becoming lost, whereby the procedure reliability of the process is ensured and the machine is protected from impurities.

The seals can be formed as a membrane from a material, preferably a metal, which is turned in on itself with an overlap perpendicular to the direction of movement. Therefore, only one single seal is used which connects all the openings with one another. This can consist e.g. of a thin metal sheet or of a metal foil, which is directed in the form of a pipe or a tube through the openings, but is flexible here in such a way that changes to the cross-sections of the openings can change the internal diameter of the pipe. Preferably, this metal membrane is formed from a sheet of metal which is turned in on itself, i.e. which is folded in to form a roll. This permits the channel, formed by the membrane, to easily change its inner contour by the region of the overlapping being able to be enlarged or made smaller. In this way, a seal which is secure and is easy to produce can be achieved.

The shaping tool can have for each opening a combination of adjustable sliders, the positions of which define the cross-section of the respective opening. Each opening is therefore defined by the intermediate space between the ends of the sliders associated with it. When the position of the sliders is changed, the cross-section of the opening changes. This adjustment of the sliders takes place here in such a way that the cross-sectional area of the opening does not change. When, therefore, individual sliders travel inwards, at the same time other sliders travel outwards, in order to guarantee a constant cross-sectional area. Of course, it is also possible to change the cross-section in such a way that the cross-sectional area changes when e.g. a changed relationship of fibre proportion and pultrusion matrix proportion is aimed for. This permits a simple and flexible controlling of the shape and/or of the size of the openings.

Each opening can be defined by two pairs of sliders, of which one pair of sliders is suitable for being adjusted in a first direction which is perpendicular to the direction of movement, whereas the other pair of sliders is suitable for being adjusted in a second direction which is perpendicular to the first direction and to the direction of movement. The openings are therefore defined by sliders standing perpendicularly to one another. These are able to define any rectangular outer contour for the pultruded profiled article which is to be pultruded. If a rounded shape is desired, this can be achieved e.g. by the introducing of a membrane, as was described above. The ends of the individual sliders can, however, also be connected with membranes which produce a seal of the intermediate space between the ends of the sliders. These membranes can also be made from metal or from any other sufficiently solid and flexible material. The combination of sliders standing perpendicular to one another is a variant which is easy to construct in order to create openings, the shape and/or size of which can be freely controlled.

The shaping tool can have means for the hydraulic or pneumatic actuating of the sliders or the sliders can be moved mechanically via a connecting link. This enables a rapid and smooth change of the cross-sections of the individual openings.

The sliders of adjacent openings can adjoin one another. The openings then already define a continuous channel through the pultrusion tool. This can make the provision of sealing means unnecessary and, in addition, permits a maximally flexible adjustability of the openings.

The sliders of adjacent openings can, however, also be spaced apart from one another. This reduces the technical complexity of the structure. Depending on the degree of impregnation of the fibre bundle, an additional guide may be necessary by means of the seals or respectively membranes described above.

The pultrusion device according to one of the previous claims can have, furthermore, a core which extends out from the impregnating tool through openings of the shaping tool, in order to produce a cavity in the fibre-reinforced profiled article. Thereby, hollow profiled articles, such as for instance pipes or suchlike, can be produced. The openings are arranged here in such a way that the core or respectively its suspension can be directed through the openings. The production of curved hollow profiled articles or respectively of hollow profiled articles with a changing cross-section is therefore also possible.

At least some of the sliders and/or the core can have channels which are suitable for directing a heating medium.

Thereby, the sliders or respectively the core become heatable, which can promote the curing of the pultrusion matrix. Hereby, the process speed and hence the output of the pultrusion device can be increased. The sliders and/or the core can be produced here by means of additive manufacture, for instance by 3D printing. This also permits line geometries for the heating medium to be used which can not be produced by conventional manufacturing methods. This can lead to an improved heating of the fibre bundle and hence a further acceleration of the production process.

The present invention is to be described more closely in the following with reference to the figures. It is self-evident that this description is purely by way of example, while the invention is defined solely through the Claims. There are shown:

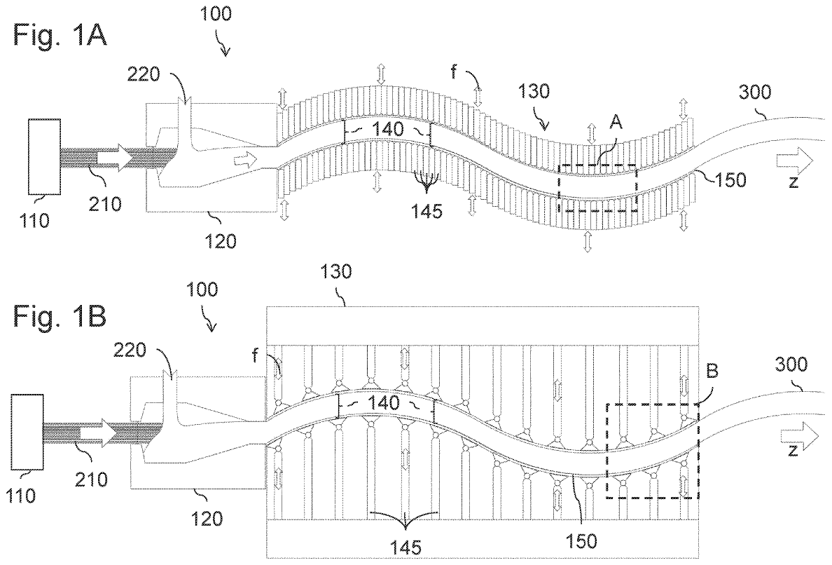

FIGS. 1A and 1B schematic views of pultrusion devices;

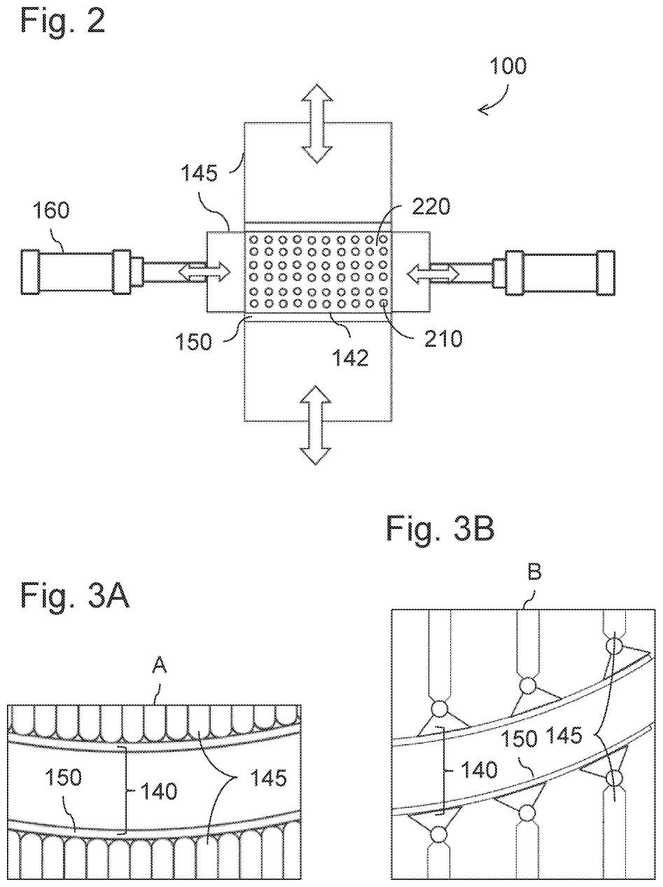

FIG. 2 a schematic view of a cross-section through one of the pultrusion devices of FIGS. 1A and 1B; and

FIGS. 3A and 3B detail views of the schematic views of the pultrusion devices of FIGS. 1A and 1B.

FIG. 1A shows schematically a section through a pultrusion device 100 along a direction of movement z of a fibre bundle 210 conveyed in the pultrusion device 100. The pultrusion device 100 has a fibre feed 110, an impregnating tool 120 and a shaping tool 130.

The fibre bundle 210 is removed from the fibre feed 110 and is directed from there into the impregnating tool 120. The fibre feed 110 can concern e.g. a plurality of fibre spools which deliver the fibres of the fibre bundle. This can concern individual fibres or else fibre fabric or suchlike. The fibre bundle 210 and the fibre feed 110 correspond here to the components known from the prior art. It is therefore unnecessary to refer to this further.

In the impregnating tool 120 the fibre bundle 210 is impregnated with a pultrusion matrix 220, for instance a resin. This step also corresponds to the conventional procedure known from the prior art. Both the impregnating tool 120 and also the pultrusion matrix 220 can be configured as known from the prior art.

Proceeding from the impregnating tool 120, the fibre bundle 210, impregnated with the pultrusion matrix 220, is moved through the shaping tool 130. In so doing, the shaping tool 130 does not move, but rather is static, as also the fibre feed 110 and the impregnating tool 120. Alternatively, the impregnating of the fibre bundle 210 with pultrusion matrix 220 can also take place within the shaping tool 130; impregnating and shaping then therefore take place at the same time. The differentiation of impregnating tool 120 and shaping tool 130 is then purely functional and not spatial, as illustrated in FIG. 1A.

The shaping tool 130 has a plurality of openings 140, the position, size and/or shape of which can be changed by movements of the elements bordering them, perpendicular to the direction of movement z, as is indicated by the arrows f.

The impregnated fibre bundle 210 travels here through all the openings 140 and thereby receives its outer contour. When the openings 140 are not arranged linearly one behind the other, the openings 140 impose on the fibre bundle 210 a curved shape within the shaping tool 130, as shown in FIG. 1A.

When the fibre bundle 210 now travels further along the direction of movement z, this curved shape is destroyed if the cross-section of the individual openings 140 would not move perpendicular to the direction of movement z during the movement of the fibre bundle 210. The change to the cross-sections of the openings 140 or respectively the displacement of the openings 140 perpendicular to the direction of movement z therefore takes place so that the shape of the curvature, i.e. the curvature figure is maintained. This means that the positions of the openings are passed on with corresponding advancing of the fibre bundle in such a way that the position of an opening 140 is subsequently taken up by the adjacent opening 140 along the direction of movement.

The fibre bundle 210 is therefore directed in curved form through the shaping tool 130. In so doing, the pultrusion matrix 220 hardens, so that at the end of the pultrusion device 100 a fibre-reinforced profiled article 300 with a curved outer contour can be removed. In this way, curved profiled articles 300 can be produced, without the conveying of the fibre bundle 210 through the shaping tool 130 having to be stopped and without moving the shaping tool 130.

Instead of the curved course which is shown, linear profiled articles 300 can also be produced with the pultrusion device 100, when all the openings 140 are arranged along a line.

Both for curved and also for linear profiled articles 300, it is possible in addition to adapt the cross-section of the profiled article 300 whilst the operation is running, i.e. without interrupting the conveying of the fibre bundle 210 through the shaping tool 130. In this case, a new cross-section is defined with the opening 140 lying next to the fibre feed 110. This step in the cross-section is then transported in a similar manner to the curvature shown in FIG. 1A by corresponding change to the shape of the cross-section of the following openings 140 through the shaping tool 130, until all the openings 140 have a cross-section corresponding to the new cross-section of the profiled article 300. Hereby, an adapting of the cross-section of the profiled article 300 is made possible in a simple manner at any time.

In order to be able to produce fibre-reinforced profiled articles 300 with consistent mechanical characteristics, it is advantageous, during the operation of the pultrusion device 100, to only permit such changes to the shape of the openings 140 in which the cross-sectional area of each individual opening 140 remains identical, whereas the shape of the cross-section can change. Thus, e.g. the transition from a rectangular to a square shape is possible, or transitions between rectangular shapes with different aspect ratios. The maintaining of the same cross-sectional area ensures that per fibre the same proportion of pultrusion matrix 220 is cured in the profiled article 300, so that independently of the shape of the cross-section, the same mechanical characteristics result from the mixture of fibres and matrix.

In FIG. 1A, each opening 140 is formed by sliders 145 directly adjacent to one another, which can be shifted perpendicular to the direction of movement z, e.g. by means of pneumatic or hydraulic drives. The sliders 145 can, however, also be adjusted in a different manner, e.g. via a mechanical connecting link.

The sliders 145 can consist e.g. of metal. The intermediate space between the sliders 145 then forms a cohesive channel, through which the fibre bundle 210 is directed. In order to give the fibre bundle 210 a particular shape, the positions of the individual sliders 145 can change continuously. In particular in the case of a curved shape, as is shown in FIG. 1A, all the sliders 145 are constantly in motion, in order to adapt the shape of the channel, formed by the inner contours of the openings 140, constantly to the desired curved shape of the profile 300. The negative of the desired shape of the profiled article 300 therefore travels through the adjusting of the sliders 145 constantly with the speed of movement of the fibre bundle 210 through the shaping tool 130. A particular portion of the fibre bundle 210, e.g. in the marked region A of FIG. 1A, is therefore always surrounded by the same contour course while it moves through the shaping tool 130.

The pultrusion matrix 220 can concern a sufficiently viscous resin that owing to the fact that the individual openings 140, or respectively the sliders 145, by which they are formed, directly adjoin one another, no additional seals have to be present between the openings 140, in order to hold the pultrusion matrix 220 to the fibres of the fibre bundle 210. However, it can also be expedient to provide seals 150 between the openings 140 or respectively also between individual sliders 145, which define an opening 140, which seals prevent pultrusion matrix 220 from being lost. In addition, such seals 150 can serve to define more clearly the channel for the fibre bundle 210 running through the openings 140, or to configure edges of the profiled article 300 more smoothly.

In FIG. 1A a membrane is shown as seal 150, which can be formed e.g. from metal. Alternatively, the membrane can be of any material which is sufficiently resistant and flexible to adapt itself to the shape change of the openings 140 and to hold the pultrusion matrix 220. The seal 150 can therefore consist e.g. of a thin metal sheet or of a metal foil, which is folded in in such a way that it forms a tube which extends substantially in the direction of movement z and has an overlap perpendicular to the direction of movement z. This wall can be actively heatable from the rear side, in order to produce a force counteracting the hydraulic pressure prevailing in the tool. The overlap is not fixed here, so that a region of the overlap can change with changes to the cross-sectional shapes of the openings 140, in order to guarantee a complete covering of the openings 140 by the seal 150. In this way, the fibre bundle 210, impregnated in pultrusion matrix 220, is securely guided through the shaping tool, without an excessive loss of pultrusion matrix 220 occurring.

Instead of the seal 150 shown in FIG. 1A, any other type of seals can also be used, which guarantee that the pultrusion matrix 220 can not escape between the individual openings 140 or respectively the sliders 145 forming them. For example, rubber seals can be provided between individual sliders 145. It is also possible to provide membranes, segmented in longitudinal and/or transverse direction, in order to increase the flexibility of the arrangement of the openings 140.

The pultrusion device 100 shown in FIG. 1A is suitable for the production of curved fibre-reinforced solid profiled articles, i.e. of profiled articles without an internal cavity. Thus, the series, produced in the shown pultrusion device 100, of upwardly and downwardly curved arcs, with separation of the individual arc segments by a saw behind the shaping tool can be used as leaf springs, as are used in the automobile industry. The provision of a cavity is not desired here.

In order to produce cavities in the profiled article 300, a core (not shown) must be introduced into the channel for the fibre bundle 210 in a manner known per se from the side of the impregnating tool 120. The core or respectively its suspension then run through all the openings. The possibility of being able to produce curved profiled articles 300 must therefore orientate itself to the shape of the suspension and of the core. For linear suspensions or respectively cores which are conventionally used, the contour of the profiled article 300 can only deviate from the linear form to the extent that the openings 140 can contain the suspension and the core. However, it is also possible to use curved suspensions. The curvature of the profiled articles which are able to be produced then corresponds substantially to the bending of the suspension. It is therefore also possible to produce curved hollow profiled articles with the pultrusion device of FIG. 1A.

In order to accelerate the curing of the pultrusion matrix 220 and thus to reduce the length of the shaping tool 130 or respectively the number of sliders 145, the openings 140 can be provided in their edge regions with heating lines through which a heating medium can flow. In particular, the tips or respectively ends of the sliders 145 can be provided with such heating lines. In addition, a core which may be present can have such heating lines in order to heat the profiled article from the interior. Such sliders or respectively cores can be produced from metal by means of additive manufacturing methods such as 3D printing, in order to produce maximally efficient heating lines which could otherwise not be produced.

The pultrusion device 100 of FIG. 1A therefore permits curved fibre-reinforced profiled articles 300 to be produced in an efficient manner, and/or to change the outer contour of profiled articles while the operation is running.

A modification of the pultrusion device 100 of FIG. 1A is illustrated in FIG. 1B. The pultrusion device 100 of FIG. 1B differs from that illustrated in FIG. 1A in that the individual openings 140 are not arranged directly adjoining one another, but spaced apart from one another. Thereby, the complexity of the shaping tool 130 can be reduced, because the shape or respectively position of few openings 140 has to be controlled.

In order to prevent an exiting of the pultrusion matrix 220 from the channel provided for the fibre bundle and in order to create a smooth outer contour without kinks for the profiled article 300, a membrane, acting as seal 150, as was described above, is arranged at the ends of the sliders 145 forming the openings 140. For this purpose, as shown in FIG. 1B, the ends of the sliders 145 can be connected to the membrane via articulations, e.g. by plates glued to the membrane. However, any other type of connection is also conceivable which permits a transfer of the position to the position of the membrane. For example, the membrane can also simply lie on the sliders 145. The movement of all sliders 145, i.e. the inner contours of all openings 140, then defines the shape of the membrane, of the fibre bundle 210 lying therein and hence of the profiled article 300 which is to be produced.

Also in the variant shown in FIG. 1B, the contour predetermined by the sliders 145 or respectively by the membrane is shifted concurrently with the speed of the fibre bundle 210 in the direction of movement z, so that individual regions of the fibre bundle 210 are always surrounded by the same contour.

FIG. 2 shows a cross-section through a pultrusion device 100 as is shown in FIG. 1A or 1B. The cross-section intersects here perpendicular to the direction of movement z through a set of the sliders 145. As shown in FIG. 2, the fibre bundle 210 embedded into the pultrusion matrix 220 is surrounded from four sides by sliders 145. The inner contour 142 of the opening 140, defined by the two pairs of sliders 145 standing perpendicular to one another, therefore determines the outer contour of the profiled article 300 consisting of cured pultrusion matrix 220 and fibres embedded therein.

Each of the sliders 145 is movable and adjustable independently of the other sliders 145, in order to achieve the greatest possible flexibility in the configuration of the cross-section of the opening 140. The movement takes place here e.g. by means 160 for the hydraulic or pneumatic actuation of the sliders. However, other actuators are also conceivable, such as e.g. electric motors or mechanical connecting links. In this way for example a consistent cross-section can be moved upwards or to the side, e.g. in order to achieve the travel of a curved contour through the shaping tool 130. The inner contour 142 or respectively the cross-section of the opening 140 can, however, also be changed in their length-to width ratio. When the two lateral sliders 145 move inwards, while the sliders 145 perpendicular thereto are moved upwards or respectively downwards, a square profiled article or an upright rectangular profiled article can be produced from the horizontal rectangular profiled article. In order to guarantee constant product characteristics after changing the cross-sectional shape, this can take place in such a way that the cross-sectional area of the opening 140 is identical before and after the change.

In order to prevent an exiting of the pultrusion matrix 220 from the intermediate space between sliders 145 standing perpendicular to one another, the seal 150 (shown extremely schematically) is present, which closes this intermediate space. This can concern here, as explained above, a membrane which is turned in on itself, the longitudinal direction of which coincides with the direction of movement z. In particular in the case of sliders 145, closely adjoining one another, of adjacent openings 140, each set of sliders 145 defining an opening can be provided with its own seal 150, such as e.g. different membranes or rubber seals fastened to the sliders 145, which can be pressed in flexibly between the sliders 145.

The arrangement of sliders 145 shown in FIG. 2 must, however, be regarded as purely by way of example. Thus, it is also possible e.g. to use three, five, six or more sliders, when the profiled articles which are to be produced are to have corresponding basic shapes. However, through the use of a membrane, turned in on itself, e.g. oval contours can also be realized with only two sliders which press e.g. from above and below onto the membrane. A slipping to the side can be prevented here by corresponding, immobile stops.

It is also possible to use aperture plates instead of the sliders 145. Here, an opening 140 consists of a hole in the aperture plate. The inner contour of the opening 140 can thus not be changed. However, it is possible to move the aperture plate perpendicular to the direction of movement z, in order e.g. to be able to produce curved contours, as was described with reference to FIGS. 1A and 1B. The arranging of the individual holes one behind the other in a non-linear manner produces the curved contour again here. This is moved through the shaping tool by adjusting the position of the perforated plates concurrently to the fibre bundle 210. Thereby also, curved profiled articles 300 can be produced in a simple manner. Through the provision of several holes with different cross-sections in a perforated plate, the outer contour of the produced profiled article can also be changed here with interrupted operation, by the fibre bundle 210 being directed through different holes.

FIGS. 3A and 3B show the regions of FIGS. 1A and 1B marked with A or respectively B in detail. It can be seen here how the ends of the sliders can lie directly on the membrane serving as seal 150 (FIG. 3A) or respectively how they are fastened on the membrane via articulations or hinges and plates adhering to the membrane (FIG. 3B). In this way, the membrane imparts the inner contours of the openings 140 to the fibre bundle 210 impregnated with the pultrusion matrix 220.

In this sense, with these configurations, the inner contours of the openings 140 define the outer contour of the produced profiled article 300.

With the present invention, as it is defined in the claims and as it was described above by way of example, it is therefore possible to provide a pultrusion device by which fibre-reinforced profiled articles can be produced without interruptions to the process sequence, which have changeable cross-sections or are curved. The pultrusion process can run continuously here and thus guarantees a high production rate.

### LIST OF REFERENCE NUMBERS

100 pultrusion device
110 fibre feed
120 impregnating tool
130 shaping tool
140 opening
142 inner contour of an opening
145 slider
150 seals
160 means for the hydraulic or pneumatic actuating of the sliders
210 fibre bundle
220 pultrusion matrix
300 fibre-reinforced profiled article

What is claimed is:

1. A pultrusion device (100) for producing fibre-reinforced profiled articles (300), comprising
a fibre feed (110) for feeding a fibre bundle (210);
an impregnating tool (120) for impregnating the fibre bundle (210) fed by the fibre feed (110) in a pultrusion matrix (220); and
a shaping tool (130) for forming and curing the fibre bundle (210) impregnated with the pultrusion matrix (220), in order to produce a fibre-reinforced profiled article (300); wherein
the shaping tool (130) is suitable for moving, in the shaping tool (130), the fibre bundle (210) impregnated with the pultrusion matrix (220) through a plurality of openings (140), the inner contours (142) of which define the outer contour of the fibre-reinforced profiled article (300) and which are each fixed in the direction of movement of the fibre bundle (210);
characterized in that
the shaping tool (130) is suitable for changing, during an operation of the pultrusion device (100), cross-sections of the openings (140) perpendicular to the direction of movement in such a way that the cross-sectional areas of the openings (140) remain constant; and
the shaping tool (130) has seals (150) which are arranged within the openings (140) and form a channel for the fibre bundle (210) impregnated with the pultrusion matrix (220) leading through all the openings (140), wherein
the seals (150) are formed as a membrane from a material which is turned in on itself with an overlap perpendicular to the direction of movement.

2. The pultrusion device (100) according to claim 1, wherein
the shaping tool (130) is suitable for changing the cross-sections of the openings (140) in such a way that the inner contours (142) of the openings define a desired curvature for the outer contour of the fibre-reinforced profile (300); and
the shaping tool (130) is suitable for changing the cross-sections of the openings (140) in such a way that the curvature is maintained on moving of the fibre bundle (210) through the openings (140).

3. (canceled)

4. (canceled)

5. The pultrusion device (100) according to claim 1, wherein
the shaping tool (130) for each opening (140) has a combination of adjustable sliders (145), the positions of which define the cross-section of the respective opening (140).

6. The pultrusion device (100) according to claim 5, wherein
each opening (140) is defined by two pairs of sliders (145); and
the one pair of sliders (145) is suitable for being adjusted in a first direction which is perpendicular to the direction of movement, and the other pair of sliders (145) is suitable for being adjusted in a second direction which is perpendicular to the first direction and to the direction of movement.

7. The pultrusion device (100) according to claim 5, wherein
the shaping tool (130) has means (160) for the hydraulic or pneumatic actuating of the sliders (145), or the sliders (145) can be moved mechanically via a connecting link.

8. The pultrusion device (100) according claim 5, wherein
the sliders (145) of adjacent openings (140) adjoin one another; or
the sliders (145) of adjacent openings (140) are spaced apart from one another.

9. The pultrusion device (100) according to claim 1, furthermore having
a core, which extends out from the impregnating tool (110) through openings (140) of the shaping tool (130), in order to produce a cavity in the fibre-reinforced profiled article (300).

10. The pultrusion device (100) according to claim 5, wherein
at least some of the sliders (145) and/or the core have channels which are suitable for directing a heating medium.

11. The pultrusion device (100) according to claim 1, wherein the membrane comprises a metal material.
